(19) United States
(12) Patent Application Publication
(10) Pub. No.: US 2016/0041557 A1
(43) Pub. Date: Feb. 11, 2016

(54) ROBOT DOLLY

(71) Applicant: Karl Patrick TROUT, Windsor, PA (US)

(72) Inventor: Karl Patrick TROUT, Windsor, PA (US)

(21) Appl. No.: 14/812,106

(22) Filed: Jul. 29, 2015

Related U.S. Application Data
(60) Provisional application No. 62/034,313, filed on Aug. 7, 2014.

(51) Int. Cl. G05D 1/02; G01C 21/20

(52) U.S. Cl. CPC G05D 1/0268; G01C 21/206

(57) ABSTRACT

A powered carrier adaptable to traverse varied programmable routes is provided. The powered carrier has a carrier platform with two independently-motorized drive wheels and a castor wheel for tripod support of the platform along a surface. Each drive wheel is coupled to a rotational sensor adapted to electronically store their respective rotational properties so as to retrievably store a plurality of programmable routes the powered carrier traverses from points A to points B. The power sources, the motors, the rotational sensors and other electronic components disposed on the powered carrier are electronically connected to a control circuitry adapted to execute a plurality of modes of operation, including modes incorporating the storage, execution and reverse-execution of the plurality of programmable routes, as well as an override mode.

### CROSS-REFERENCE TO RELATED APPLICATION

This application claims the benefit of priority of U.S. provisional application No. 62/034,313, filed 7 Aug. 2014, the contents of which are herein incorporated by reference.

### BACKGROUND OF THE INVENTION

The present invention relates to powered carriers and, more particularly, to a programmable powered carrier adaptable to traverse varied programmable routes.

Current programmable powered carriers or transport robots are too expensive, large, heavy, inflexible, and complicated for home use. Because of these things they are especially not suited for use by the elderly or the physically challenged. During a typical week, one must move large heavy objects or many small cumbersome objects around their household or business. For example, refuse must be taken to the curb for pickup, laundry must be carted to the laundry room, and groceries must be carted from the car to the kitchen. This can be burdensome and difficult for elderly people and even those with temporary physical ailments, such as sore joints. In addition, some of these things that must be carted sometimes require exposure to inclement weather.

Current programmable powered carriers or transport have several problems for the home user. First, they are very expensive for the average homeowner to buy or use, which makes them an impractical solution to the problem described. Second, they are not specifically designed for home use. They often require a line on the floor in order to guide the robot along its path. This is not practical for the homeowner because as paths change, this would require removing lines and placing new lines down, and the lines would not fit into the decor of a home. Thirdly, these robots are not easily programmed or adjusted. Fourth, they are very heavy for a home owner, and could pose a hazard if they become stuck in a hallway because they cannot be easily moved or pushed out of the way. A fifth problem is they are not designed to carry a variety of bins, baskets or containers. A sixth problem is that these robots often use more than three wheels which can cause problems with traction. Traction on level, smooth hospital or factory floors is easy, but around the home there are transitions that occur between carpeted and uncarpeted rooms, as well as small bumps in sidewalks and driveways. Industrial transport robots used in hospitals and factories are not designed to be used outdoors in the elements. There are numerous other issues with these industrial robots that make them impractical for household use, for example their large physical size.

As can be seen, there is a need for a lightweight, powered bin-carrier adaptable to traverse varied programmable routes.

### SUMMARY OF THE INVENTION

In one aspect of the present invention, a powered carrier adaptable to traverse programmable routes includes a platform extending along a horizontal axis; two independently-motorized drive wheels, each rotatably mounted to a first portion of the platform; a castor wheel mounted to a second portion of the platform so as to be pivotable about a vertical axis; two rotational sensors mounted to the platform, each rotational sensor configured to sense a plurality of rotational properties of each drive wheel; and a control circuitry mounted to the platform, wherein the control circuitry is electronically connected to the two rotational sensors and the two independently-motorized drive wheels, wherein the control circuitry is configured to steer the two drive wheels through a plurality of programmable routes based in part on the plurality of rotational properties sensed by the two rotational sensors.

In another aspect of the present invention, a powered carrier adaptable to traverse programmable routes includes a platform extending along a horizontal axis; two independently-motorized drive wheels, each rotatably mounted to a first portion of the platform; a rotational sensor rotatably mounted to each drive wheel; a castor wheel mounted to a second portion of the platform so as to be pivotable about a vertical axis; two rotational sensors mounted to the platform, each rotational sensor configured to sense a plurality of rotational properties of each rotational sensor; at least one obstacle sensor disposed near the first portion of the platform so as to detect obstructions along each programmable route; and a control circuitry mounted to the platform, wherein the control circuitry is electronically connected to the two rotational sensors and the two independently-motorized drive wheels, wherein the control circuitry is configured to steer the two drive wheels through a plurality of programmable routes based in part on the plurality of rotational properties sensed by the two rotational sensors, wherein the control circuitry is further configured to provide a plurality of modes of operation including: a program mode for retrievable storing the plurality of programmable routes; a go mode for executing the plurality of programmable routes; a return mode for executing a reverse of the plurality of programmable routes, wherein the return mode further comprises an initial 180 degree rotations of the platform executed by the two independently-motorized drive wheels prior to executing a reverse of a most recent programmable route; and an override mode for steering the independently-motorized drive wheels.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a front view of an exemplary embodiment of the present invention;

FIG. 3 is a rear view of an exemplary embodiment of the present invention;

FIG. 4 is a bottom view of an exemplary embodiment of the present invention;

FIG. 5 is a top view of an exemplary embodiment of the present invention;

FIG. 6 is a side view of an exemplary embodiment of the present invention;

FIG. 7 is a perspective view of an exemplary embodiment of a wireless remote control of the present invention;

FIG. 8 is a perspective view of an exemplary embodiment of a control box of the present invention;

FIG. 9 is a side view of an exemplary embodiment of the present invention, shown in use;

FIG. 10 is a schematic view of an exemplary embodiment of the present invention; and

FIG. 11 is a continuation of FIG. 10 illustrating the schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a powered carrier adaptable to traverse varied programmable routes. The powered carrier has a carrier platform with two independently-motorized drive wheels and a castor wheel for tripod support of the platform along a surface. Each drive wheel is coupled to a rotational sensor adapted to electronically store their respective rotational properties so as to retrievably store a plurality of programmable routes the powered carrier traverses from points A to points B. The power sources, the motors, the rotational sensors and other electronic components disposed on the powered carrier are electronically connected to a control circuitry adapted to execute a plurality of modes of operation, including modes incorporating the storage, execution and reverse-execution of the plurality of programmable routes, as well as an override mode.

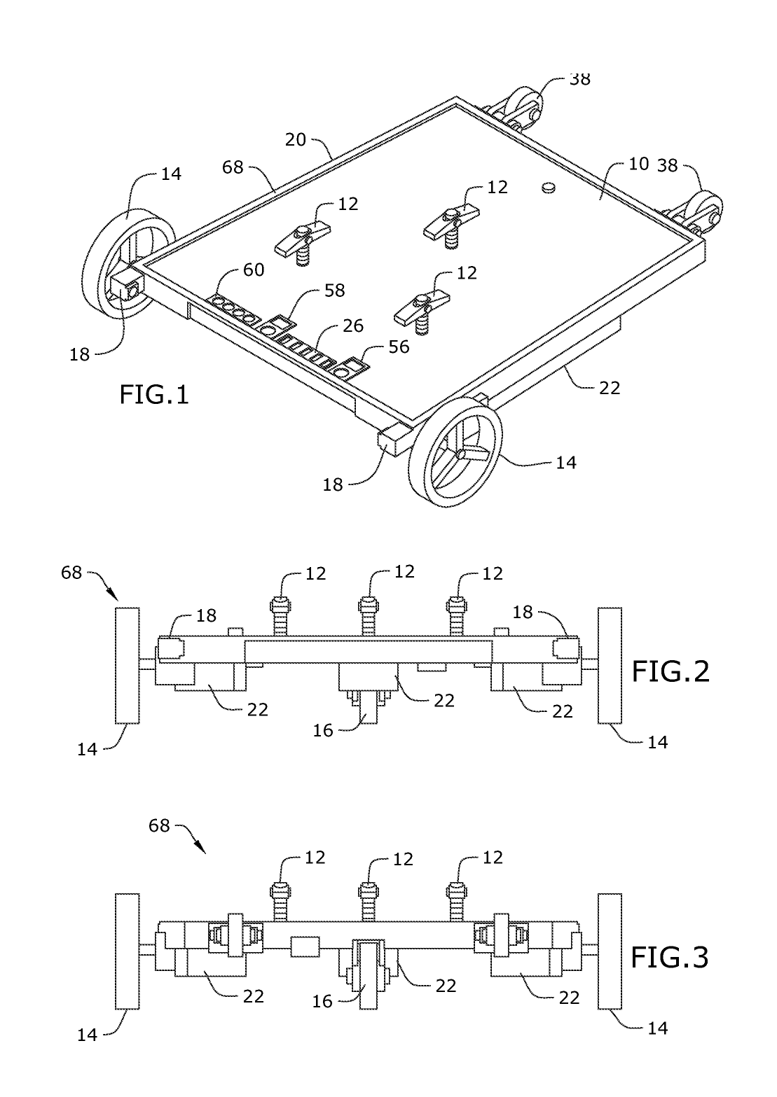

Referring to FIGS. 1 through 9, the present invention may include a motorized robot dolly 68 having a generally rectangular platform 10 with at least two drive wheels 14 and a castor wheel 16 for supporting the platform 10 along a supporting surface 64. The two drive wheels 14 may each be independently coupled to a motor 28 with a gear box/axle by a coupling unit 30. Each motor 28 may be dedicated for driving its coupled drive wheel 14, enabling differing speed and timing of the two drive wheels 14 for differential steering and the like. The two drive wheels 14 may be rotatably mounted along a first portion of the platform 10; and the castor wheel 16 may be mounted near an opposing second portion of the platform 10. The castor wheel 16 may be pivotable about a vertical axis by a free swivel 62. The two drive wheels 14 and the castor wheel 16 may form a tripod support that will guarantee wheel contact on uneven surfaces, enabling reliable transitions among varying types of the supporting surfaces 64; for example, during transitions that occur between carpeted and uncarpeted rooms, as well as small bumps in sidewalks and driveways.

It should be understood that terms referencing “upward,” “downward,” “underside” and the like are generally defined relative to the direction of gravity and the supporting surface 64, with gravity directed generally “downward” toward the supporting surface 64.

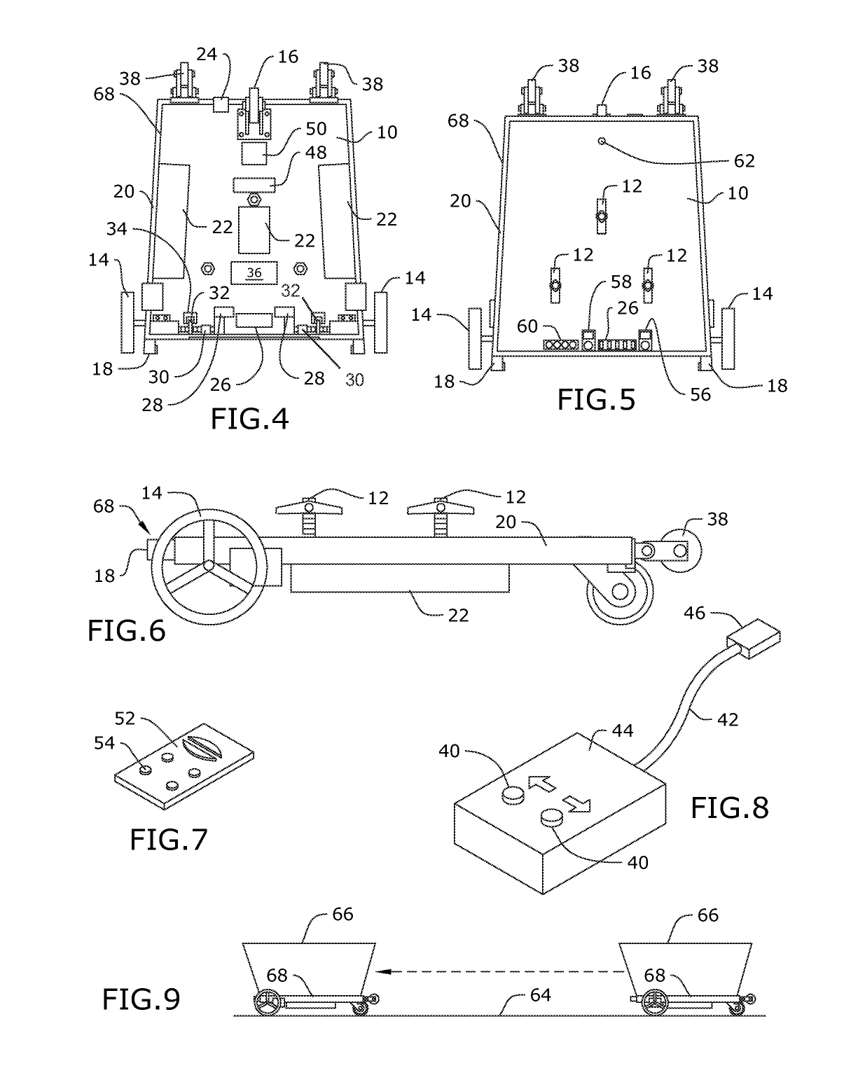

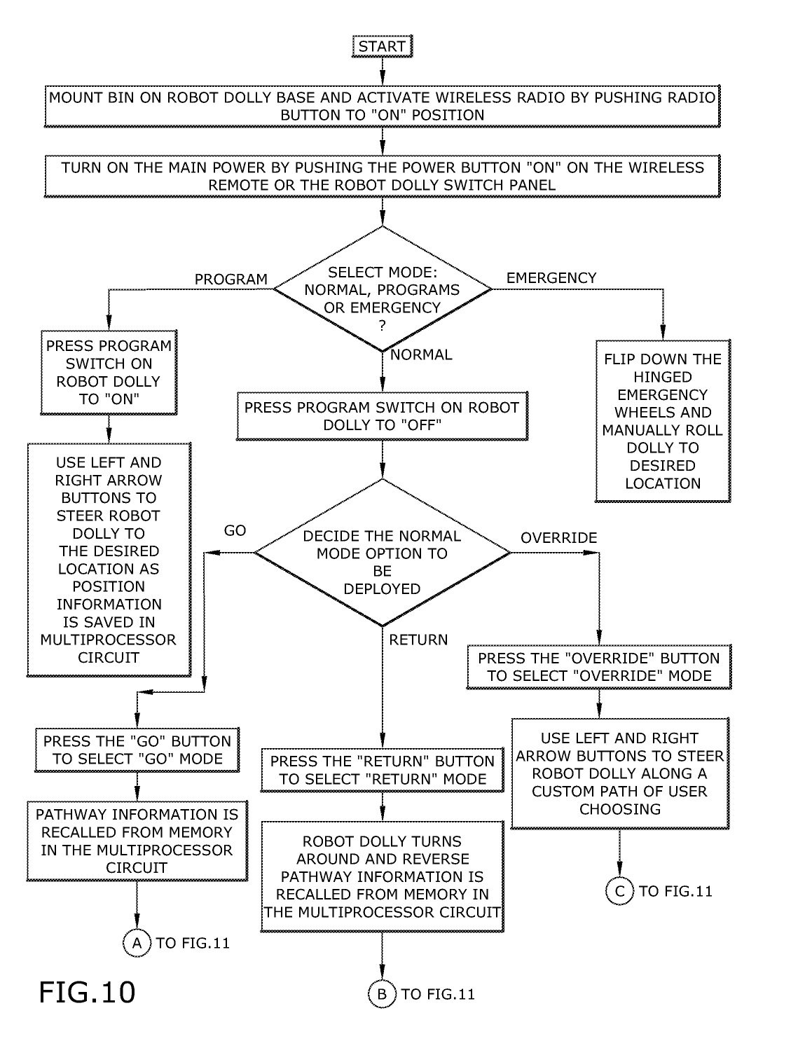

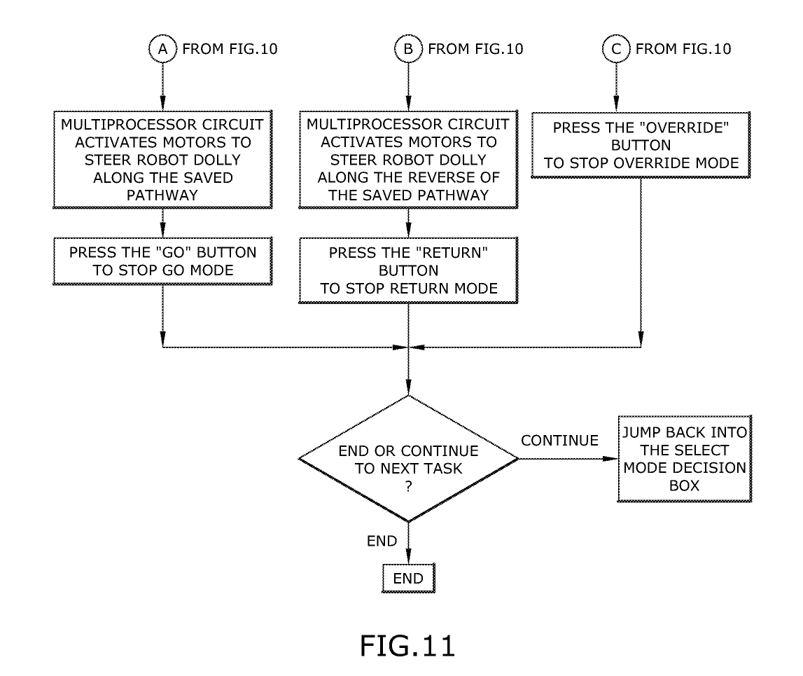

The present invention may include a rotational sensor 32 rotably mounted to each gear axle corresponding to the drive wheels 14, as illustrated in FIG. 4. As a result, the rotational properties of each rotational sensor 32 equals or is at least proportional to the rotational properties of their corresponding drive wheels 14. The rotational properties may include but not be limited to the number and rate of rotations along a predetermined path or route.

The platform 10 may be dimensioned and adapted to sufficiently accommodate various bins 66 for transporting household or business items, such as groceries, refuse, laundry, computer equipment and the like. A plurality of toggle bolts 12 or other bin-securing mechanisms may be disposed on an upward-facing surface of the platform, as illustrated in FIGS. 1 through 3, for mounting the various bins 66 thereto. A pair of hinged emergency wheels 38 may be disposed along a periphery of the platform 10, wherein the pair of hinged emergency wheels 38 may be adapted to manually roll the robot dolly 68 in an emergency or in case of failure. The platform 10 may also include a peripheral trim 20 and at least one light panel 60.

The platform 10 may support the electronics and other components needed to facilitate the self-powered programmable motorization of the robot dolly 68. A plurality of power sources 22 may be disposed along the platform 10, as illustrated in FIGS. 2 through 4. The power sources 22 may include batteries or the like for powering the robot dolly 68 and so may be electrically connected to the following supporting electronic components disposed along the platform 10: the at least one light panel 60, a power button with indicator light 56, a timer circuit 48, a wireless radio circuit 50, a wireless power button with indicator light 58, at least one obstacle sensor 18, and a corded-remote socket 24.

The timer circuit 48 may be adapted to automatically cut the power sources 22 to nearly every electronic components after a predetermined time, for example ten minutes, in order to conserve the power sources 22. The at least one obstacle sensor 18 may be disposed near the first portion of the platform 10, wherein the at least one obstacle sensor 18 may be adapted to detect obstructions in the path of the robot dolly 68 so that power source 22 can be cut until the obstruction is removed. The main power button 56 may be used to manually turn on power source 22 to the dolly robot 68 if desired.

The robot dolly 68 can also be controlled, programmed and turned on using either a wireless remote control 52 with associated control buttons and switches 54 or a control box 44 with associated control button and switches 40. The wireless remote control 52 may be a wireless radio or the like that works by wirelessly triggering the wireless radio circuit 50. The wireless remote 52 may also be electrically connected with the separate wireless power button 58 so that the wireless radio can be left in the on state for wireless control, or turned off if the wired control box 44 is preferred. The control box 44 may be electronically connected to the corded-remote socket 24 via a box plug 46 and an electric wire cord 42 to duplicate the function of the wireless radio circuit 50 and wireless remote control 52 present herein.

The present invention may also electronically connect the electronic components and the motors 28 to a control circuitry 36, a switch panel 26 and two rotational sensors 34 disposed on the platform 10, all of which are at least indirectly powered by the plurality of power sources 22. The control circuitry 36 may include at least one processing unit having a form of memory, including a microprocessor, a computer or the like. For the corded and the wireless control configurations, the corded-remote socket 24 and the wireless radio circuit 50 are interfaced, respectively, with the control circuitry 36.

Each rotational sensor 34 may be mounted along the first portion so as to sense the rotational properties of its dedicated rotational sensor 32. For example, a rotational sensor 34 may be mounted across from its corresponding rotational sensor 32, as illustrated in FIG. 4. Each rotational sensor 34 may be interfaced with the control circuitry 36 for providing it input to be processed.

The switch panel 26 may be adapted to switch/toggle the control circuitry 36 among a plurality of modes of operation. The control circuitry 36 may be adapted to provide a plurality of logical loops and steps, including but not limited to, the driving of the following modes of operation: (a) OVERRIDE MODE—Override mode may selected with a switch on the switch panel 26, or one of control buttons 54, 40, so as to cause a particular pin on the control circuitry 36 to change voltage or otherwise activate the left or right motors 28 to drive and steer the robot dolly 68 as desired; (b) PROGRAM MODE—Program mode may selected with a switch on the switch panel 26, or one of control buttons 54, 40, so as to cause a particular pin on the control circuitry 36 to change voltage or otherwise activate—as the robot dolly 68 is steered with the wireless remote 52 (or control box 44)—the tracking and storing of the rotational properties of each rotational sensor 32 and so each corresponding drive wheel 14, thus enabling the retrievable electronic storage of a plurality of stored programmed paths/routes from points A to points B that the robot dolly 68 traversed; (c) GO MODE—Go mode may selected with a switch on the switch panel 26, or one of control buttons 54, 40, so as to cause a particular pin on the control circuitry 36 to change voltage or otherwise activate the robot dolly 68 to traverse one of the plurality of stored programmed paths/routes; and (d) RETURN MODE—Return mode may selected with a switch on the switch panel 26, or one of control buttons 54, 40, so as to cause a particular pin on the control circuitry 36 to change voltage or otherwise activate the robot dolly 68 to execute a tight 180 degree rotation and then perform the last executed stored path/route but in reserve, so as to return to point A. In certain embodiments, the return mode may used together with Override mode to be able to rotate the dolly robot 68 in the tight circular path as one drive wheel 14 runs in the forward direction while the other drive wheel 14 runs in the reverse direction. When Return mode is used on its own, the robot dolly 68 may automatically turn and follow the last programmed path/route backwards returning the robot dolly 68 from whence it came.

A computer program used in the control circuitry 36 may provide the detailed logic to execute the plurality of modes of operation. The control circuitry 36 may be interfaced with the at least one light panel 60 adapted to visually indicate to a user which is the current mode of operation.

A method of using the present invention may include the following. The robot dolly 68 disclosed above may be provided. Once sufficiently powered, the user would mount a predetermined bin 66 to the upward facing portion of the platform by using the toggle bolts 12 or other bin-securing mechanisms. Then using the wireless remote 52 (or control box 44), the user may program the preferred route of the robot dolly 68 between a predetermined point A and a predetermined point B. Then the robot dolly 68 with predetermined bin 66 would be returned to the predetermined point A. When the user wants to transport the predetermined bin 66 to the predetermined point B, they simply push the appropriate control buttons 54, 40 and the robot dolly 66 will automatically deliver the predetermined bin 66 to the programmed predetermined point B.

The present invention may be specifically designed with the numerous transporting tasks of the household in mind and is meant to be flexible, affordable and easy to use by even the elderly, and is adaptable to a large number of paths which may change from time to time. It can be used indoors and outdoors. Furthermore, the robot dolly 68 may use three wheels for a tripod support guaranteeing that all wheels maintain contact with the supporting surfaces 64 as it transitions among (even uneven) surfaces, preventing wobbling and assuring the drive wheels 14 function properly. The present invention may be controlled from a distance with the wireless remote control 52 for quick changes in paths, or work by following a programmed route for regular chores. It is easily programmed using the wireless remote control 52, and requires little knowledge or thought for operation.

The powered robot dolly 68 may be designed to be used either indoors or for a temporary period of time outdoors. It is versatile in that almost any bin 66, be it a can, basket or the like, may be mounted onto it via the toggle bolts 12 or other bin-securing mechanisms. The powered robot dolly 68 may be programmed to take a particular route relieving one from manually assisting in the process of transporting a predetermined bin 66. One can mount the bin 66 and program the robot dolly 68 to move from their front door to the kitchen area, for example, then when arriving home with groceries, put the groceries in the bin 66, push a control button 54, 40 and the robot dolly 68 will drive itself to the kitchen.

It should be understood, of course, that the foregoing relates to exemplary embodiments of the invention and that modifications may be made without departing from the spirit and scope of the invention as set forth in the following claims.

What is claimed is:

1. A powered carrier adaptable to traverse programmable routes, comprising:
a platform extending along a horizontal axis;
two independently-motorized drive wheels, each rotatably mounted to a first portion of the platform;
a castor wheel mounted to a second portion of the platform so as to be pivotable about a vertical axis;
two rotational sensors mounted to the platform, each rotational sensor configured to sense a plurality of rotational properties of each drive wheel; and
a control circuitry mounted to the platform, wherein the control circuitry is electronically connected to the two rotational sensors and the two independently-motorized drive wheels, wherein the control circuitry is configured to steer the two drive wheels through a plurality of programmable routes based in part on the plurality of rotational properties sensed by the two rotational sensors.

2. The powered carrier of claim 1, further comprising a rotational sensor rotatably mounted to each drive wheel, and wherein each rotational sensor is configured to sense a plurality of rotational properties of each rotational sensor.

3. The powered carrier of claim 1, further comprising a plurality of toggle bolts mounted to an upper side of the platform.

4. The powered carrier of claim 1, further comprising a pair of emergency hinged wheels mounted to a periphery of the platform.

5. The powered carrier of claim 1, wherein the control circuitry is further configured to provide a plurality of modes of operation comprising:
a program mode for retrievable storing the plurality of programmable routes;
a go mode for executing the plurality of programmable routes; and
a return mode for executing a reverse of the plurality of programmable routes.

6. The powered carrier of claim 5, wherein the return mode further comprises an initial 180 degree rotations of the platform executed by the two independently-motorized drive wheels prior to executing a reverse of a most recent programmable route.

7. The powered carrier of claim 5, wherein the plurality of modes of operation further comprises an override mode for steering the independently-motorized drive wheels.

8. The powered carrier of claim 7, further comprising at least one light panel mounted to the platform, wherein the at least one light panel is configured to visually indicate a current mode of operation.

9. The powered carrier of claim 1, further comprising at least one obstacle sensor disposed near the first portion of the platform so as to detect obstructions along each programmable route.

10. A powered carrier adaptable to traverse programmable routes, comprising:
a platform extending along a horizontal axis;
two independently-motorized drive wheels, each rotatably mounted to a first portion of the platform;
a rotational sensor rotatably mounted to each drive wheel;
a castor wheel mounted to a second portion of the platform so as to be pivotable about a vertical axis;
two rotational sensors mounted to the platform, each rotational sensor configured to sense a plurality of rotational properties of each rotational sensor;
at least one obstacle sensor disposed near the first portion of the platform so as to detect obstructions along each programmable route; and
a control circuitry mounted to the platform, wherein the control circuitry is electronically connected to the two rotational sensors and the two independently-motorized drive wheels, wherein the control circuitry is configured to steer the two drive wheels through a plurality of programmable routes based in part on the plurality of rotational properties sensed by the two rotational sensors,
wherein the control circuitry is further configured to provide a plurality of modes of operation comprising:
a program mode for retrievable storing the plurality of programmable routes;
a go mode for executing the plurality of programmable routes;
a return mode for executing a reverse of the plurality of programmable routes, wherein the return mode further comprises an initial 180 degree rotations of the platform executed by the two independently-Page motorized drive wheels prior to executing a reverse of a most recent programmable route; and
an override mode for steering the independently-motorized drive wheels.
